(19) United States
(12) Patent Application Publication
(10) Pub. No.: US 2025/0284249 A1
(43) Pub. Date: Sep. 11, 2025

(54) SHOT TIMER

(71) Applicant: Target Eagle Technologies, Inc, Irvine, CA (US)

(72) Inventor: Amin Nemati, Irvine, CA (US)

(73) Assignee: Target Eagle Technologies, Inc, Irvine, CA (US)

(21) Appl. No.: 18/600,492

(22) Filed: Mar. 8, 2024

(51) Int. Cl. G04F 10/00; G06V 40/10; G06V 40/20

(52) U.S. Cl. CPC G04F 10/00; G06V 40/10; G06V 40/20

(57) ABSTRACT

Systems and methods for timing the discharge of a firearm using a shot timer are described herein. The shot timer uses multiple levels of verification. A first level includes analyzing the audio signal to determine if a sound received is associated with the discharging of a firearm. A second level includes analyzing the posture of individuals to eliminate individuals that likely are not the individuals that discharged the firearm. A third level includes analyzing the movement of one or more firearms to determine which firearm was the source of the audio signal.

### BACKGROUND

Shot detection and timing systems can be used in various environments. For examples, shot detection and timing systems can be used in shooting competitions. In these competitions, an audio, visual, or tactile start signal is used to start the competition. The shot timer is used to track a competitor's time by detecting the sound of shots fired by a weapon used by the competitors. The elapsed time between the start signal and the detected one or more shots is recorded and used to determine a competitor's score. A shot timer can also be used to train first responders or military personnel. For example, a shot timer can be used to track data such as how quickly trainees are performing certain actions such as unholstering a gun, shooting one or more targets, and reloading.

Some conventional shot timers use one or more microphones to detect the sound of a shot being fired and record the elapsed time from the start signal to the detection of the sound. The shot timers use audio processing technologies that recognize the compressive sound of a shot being fired from a weapon. Some conventional shot timers are wearable devices that may use a combination of microphones and accelerometers to detect and record shooting data. The accelerometers can be used to sense movements such as a weapon being unholstered and holstered. However, these conventional systems can have some drawbacks. For example, in some situations, such as during training and competition, there may be more than one person firing their weapon during the same proximate time. If the weapons are fired simultaneously or nearly simultaneously with different calibers of weapons, conventional shot timers may not be able to identify which shooter fired which shot. Further, echoes or other loud noise may be detected as false positives. Additionally, in some situations, a shot timer may not detect that more than one shot was fired. Further, shot timers worn by a user can be difficult to synchronize, resulting in potentially erroneous data.

### BRIEF DESCRIPTION OF DRAWINGS

FIG. 1 is an illustration of a range that uses a shot timer to detect and record firearm discharge times, in accordance with one or more examples of the present disclosure.

FIG. 2 illustrates an audio signal representing audio generating by a firearm and an audio signal generated by a person yelling near a shot timer, in accordance with one or more examples of the presently disclosed subject matter.

FIG. 3 illustrates an audio signal representing audio generating by a firearm and an audio signal stored in the sound data store, in accordance with one or more examples of the presently disclosed subject matter.

FIG. 4 is an illustration of a shot sound user interface configured to receive inputs to identify a sound signal for storage in a sound data store, in accordance with one or more examples of the presently disclosed subject matter.

FIG. 5 illustrates the use of skeleton tracking to determine which, if any, individual discharged a firearm, in accordance with one or more examples of the presently disclosed subject matter.

FIG. 6 illustrates a firearm in a pre-discharge position and a post-discharge position, in accordance with one or more examples of the presently disclosed subject matter.

FIG. 7 illustrates a method for timing discharges of a firearm, in accordance with various examples of the presently disclosed subject matter.

FIG. 8 depicts a component level view of the shot timer 102 for use with the systems and methods described herein, in accordance with various examples of the presently disclosed subject matter.

### DETAILED DESCRIPTION

The presently disclosed subject matter is directed to a hybrid shot timer that uses multilayer verification technologies to verify shots (or discharges of a firearm). Each of the layers of verification are used to reduce the probability of having a false positive and, in some examples, to identify which individual discharged their firearm, along with other advantages discussed below. In a first layer of verification, the hybrid shot timer uses audio processing technologies to discriminate between the sound a discharging firearm makes and other loud sounds. In a second layer of verification, the hybrid shot timer uses pre-discharge visual processing technologies to discriminate between individuals having body movements indicative of a person ready or currently discharging their firearm and other individuals either at rest or not discharging their firearms. In some examples, a camera of the hybrid shot timer uses skeletal tracking to identify and track those body movements as well as movements of the firearm. In a third layer of verification, the hybrid shot timer uses post-discharge visual processing technologies to discriminate between individuals in a ready position (i.e., ready to discharge their firearm) and the individuals that have discharged their firearm. In some examples, the post-discharge visual processing technologies use movements of the individual (e.g., such as someone experiencing a recoil of the firearm), movements of the firearm (e.g., the movement of the firearm's slide or the movement upwards of the firearm itself), and/or a muzzle flash to identify the individual associated with the sound of a firearm being discharged received at the hybrid shot timer.

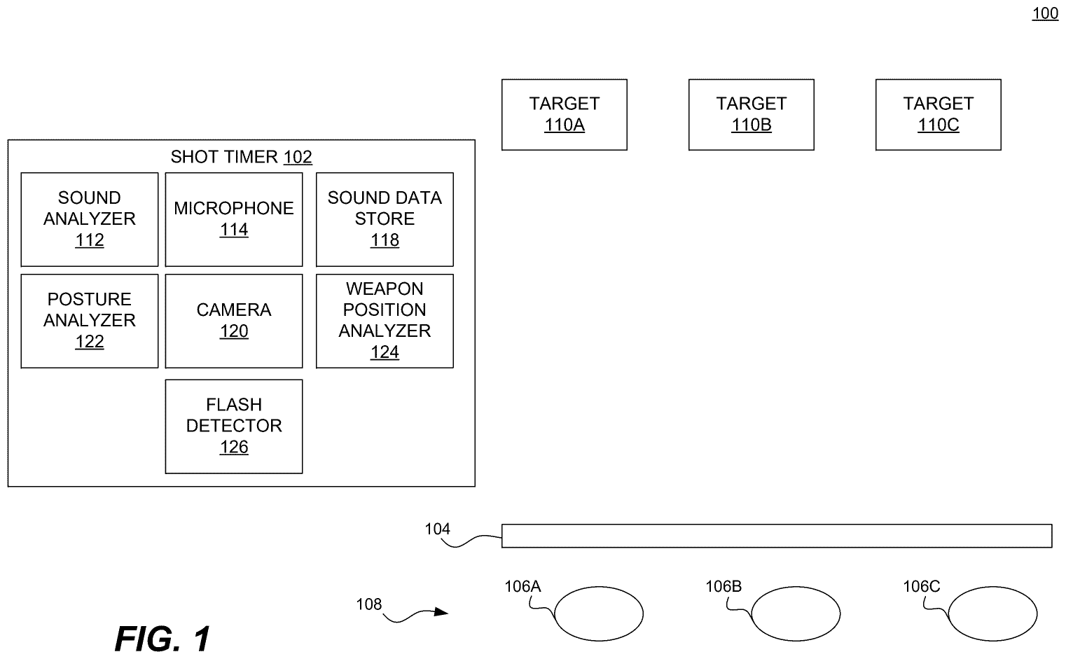

Turning to the figures, whereby wherever possible the same reference numbers will be used throughout the drawings to refer to the same or like parts, FIG. 1 is an illustration of a range 100 that uses a shot timer 102 to detect and record firearm discharge times, in accordance with one or more examples of the present disclosure. In some examples, one or more of the functions of the shot timer 102 may be performed on a user device, a central server, or both the user device and the central server. In some examples, the shot timer 102 is one or more devices having computer-executable instructions stored thereon that perform the functions described herein. In further examples, the shot timer 102 may be an application on a user device (such as a cell phone) capable of performing the functions described herein. In still further examples, the shot timer 102 may be a standalone computer having computer-executable instructions stored thereon that perform the functions described herein. In additional examples, the shot timer 102 may be more than one device, software module, computer, or device. The present disclosure includes these and other configurations of the shot timer 102.

The range 100 includes a firing line 104. Users 106A, 106B, and 106C (hereinafter referred to individually as “the user 106A,” “the user 106B,” and “the user 106C,” and collectively as “the users 106”) are typically instructed to stay behind the firing line 104 in area 108 to help maintain the safety of the users 106 while firearms are loaded and active on the range 100. The users 106 may discharge their firearms (not illustrated) to shoot at targets 110A, 110B, and/or 110C (hereinafter referred to individually as “the target 110A,” “the target 110B,” and “the target 110C,” and collectively as “the targets 110”). It should be noted that use of the range 100 in FIG. 1 is merely for the purposes of illustrating an example of the present disclosure, as the shot timer 102 may be used in other environments, which are considered to be within the scope of the present disclosure. For example, the shot time 102 may be used in close combat training environments, indoor and outdoor training sessions or environments, and other environments in which the functions of shot detection and timing using the shot timer 102 may be used.

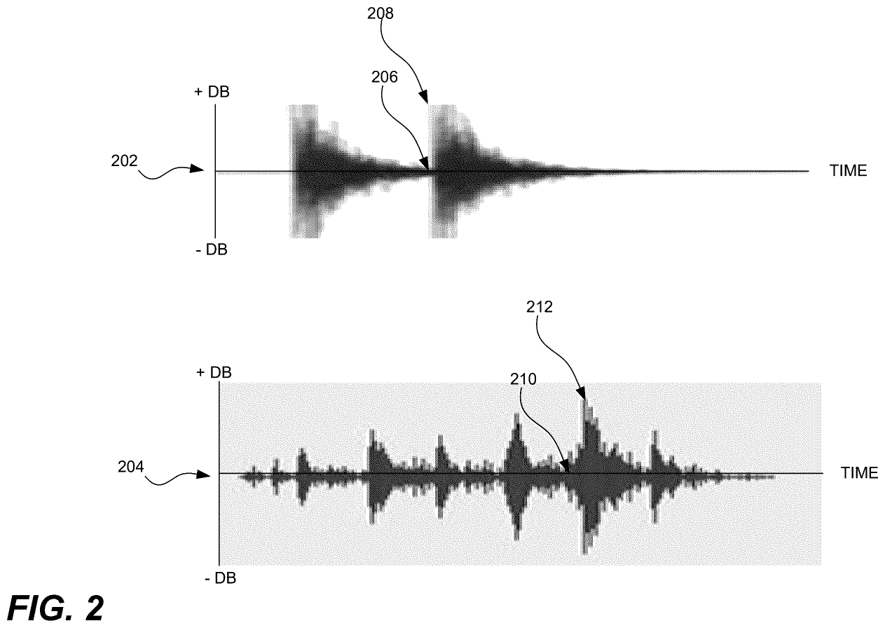

As noted above, in some examples, if one of the users 106 discharges their firearm at or near the same time as another one of the users 106, the sound generated by the firearms may arrive at the shot timer 102 at or near the same time. Further, in some examples, there may be other loud noise, such as people yelling and the like, that may be received at the shot timer 102. Thus, in a first level of shot identification discrimination, the shot timer 102 includes a sound analyzer 112. The sound analyzer 112 is configured to receive audio signals using a microphone 114 installed on the shot timer 102 or otherwise accessible for use by the shot timer 102. In some examples, the microphone 114 may be a component of another device that transmits the audio signals to the sound analyzer 112 of the shot timer 102 for audio processing. Upon receipt of the audio signal, the sound analyzer 112, in a first level of shot detection discrimination, analyzes the audio signal to determine if the audio signal represents the sound generated by the discharge of a firearm, explained by way of example in FIG. 2.

FIG. 2 illustrates an audio signal 202 representing audio generating by a firearm and an audio signal 204 generated by a person yelling near the shot timer 102, in accordance with one or more examples of the presently disclosed subject matter. Both the audio signals 202 and 204 are analyzing using an XY grid, with the X axis representing sound intensity in decibels (dB) and the Y axis representing the sound over a period of time. As illustrated in FIG. 2, while having similar intensities, the audio signal 202 of the firearm being discharged has a different waveform than the audio signal 204 of the person yelling. For example, the audio for a second discharge of a firearm, starting at time 206 reaches a maximum amplitude in a shorter period of time, indicated by time 208. By contrast, the audio for the beginning of a shout or yell, indicated at time 210, and the time to reach a maximum amplitude, indicated at time 212, is longer than the time between time 206 and time 208 of the audio signal 202. In this example, because the audio signal 204 does not include a rise in amplitude similar to the audio signal 202, if received by the shot timer 102, the shot timer 102 may disregard the audio signal 204.

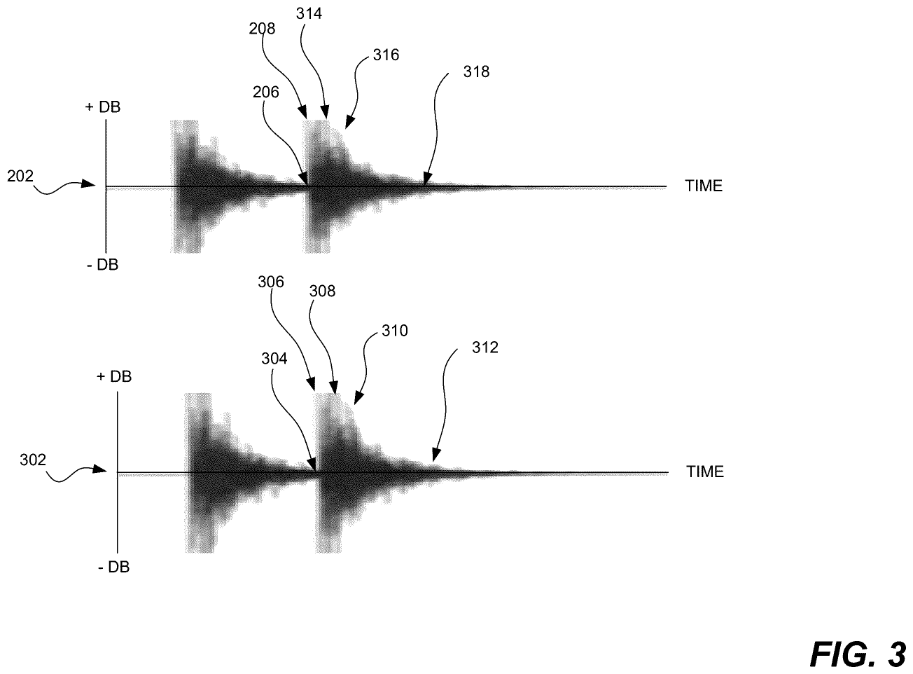

It should be noted that there are other technologies for distinguishing between an audio signal generated by a discharged firearm and other audio signals, which are considered to be within the scope of the present disclosure. Returning to FIG. 1, for example, the shot timer 102 may include a sound data store 118. The sound data store 118 may be a database having stored therein one or more audio signals representing different sounds. These different sounds can be used by the shot timer 102 to match a sound signal received by the microphone 114 to a sound stored in the sound data store. The matching operation may be done for various reasons. For example, a received sound may be matched against a previously stored sound to identify a model of firearm discharged, as different firearms may have different sound signals specific to the particular firearm. Further, the stored sound signals may be used to verify an initial determination that an audio signal received by the shot timer 102 represents the sound generated when the firearm was discharged, described by way of example in FIG. 3.

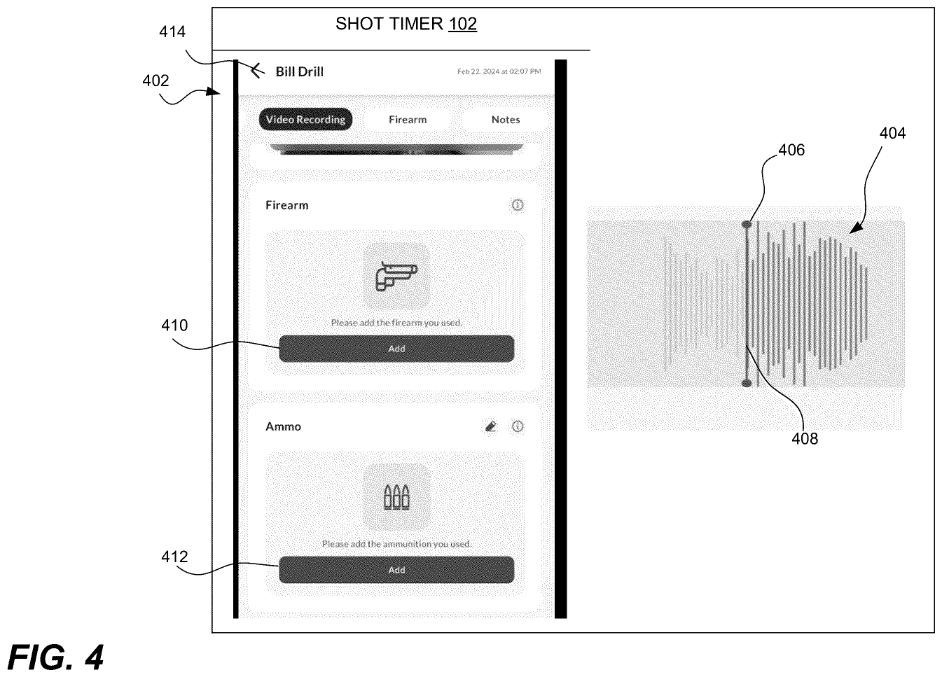

FIG. 3 illustrates the audio signal 202 representing audio generating by a firearm and an audio signal 302 stored in the sound data store 118, in accordance with one or more examples of the presently disclosed subject matter. The audio signal 302 includes audio reference points 304, 306, 308, 310, and 312, which are portions of the audio signal 302 at various times, beginning at the beginning at reference point 304 and ending at reference point 312. The sound analyzer 112 identifies reference points 206, 208, 314, 316, and 318 on the audio signal 202, which was received at the microphone 114 of the shot timer 102. The sound analyzer 112 compares the reference points of the audio signal 202 against the audio signal 302 and can determine that the audio signal 202 was generated by the firearm used to generate the audio signal 302 if the reference points are within a predetermined time and/or intensity. In some examples, the audio signals stored in the sound data store 118 can include audio signals generated from various sources such as the discharging of firearms and other sources such as an explosion, human sounds, and other sound sources. The audio signals stored in the sound data store 118 can be provided by a third-party service that records audio signals from various sources. In other examples, the audio signals stored in the sound data store 118 can be generated and identified by a user of the shot timer 102, shown by way of example in FIG. 4.

FIG. 4 is an illustration of a shot sound user interface 402 configured to receive inputs to identify a sound signal for storage in the sound data store 118, in accordance with one or more examples of the presently disclosed subject matter. The shot sound user interface 402 may be generated and displayed by the shot timer 102 to allow a user to input data relating to a specific sound signal received at the shot timer 102. In the example illustrated in FIG. 4, a sound signal 404 is provided and displayed in the user interface 402. The sound signal 404 is audio received at the shot timer 102. The user interface 402 includes a sound identifier 406 that the user can move to various parts of the audio signal 404. In FIG. 4, the sound identifier 406 has been placed over sound portion 408 of the audio signal 404. The user interface 402 includes firearm input 410 and ammunition input 412. The firearm input 410 is configured to receive an input indicating the type of firearm used to generate the sound portion 408. The ammunition input 412 is configured to receive an input indicating the type of ammunition used by the firearm indicated using the firearm input 410 to generate the sound portion 408. Further, in some configurations, a user may input their name 414 when using the user interface 402. Thus, using the data received the shot timer 102 can store the name of the person inputting the information (which may also be the person discharging the firearm), the time in which a firearm was discharged, the type of firearm that generated the audio signal 404, and the ammunition used when discharging the firearm.

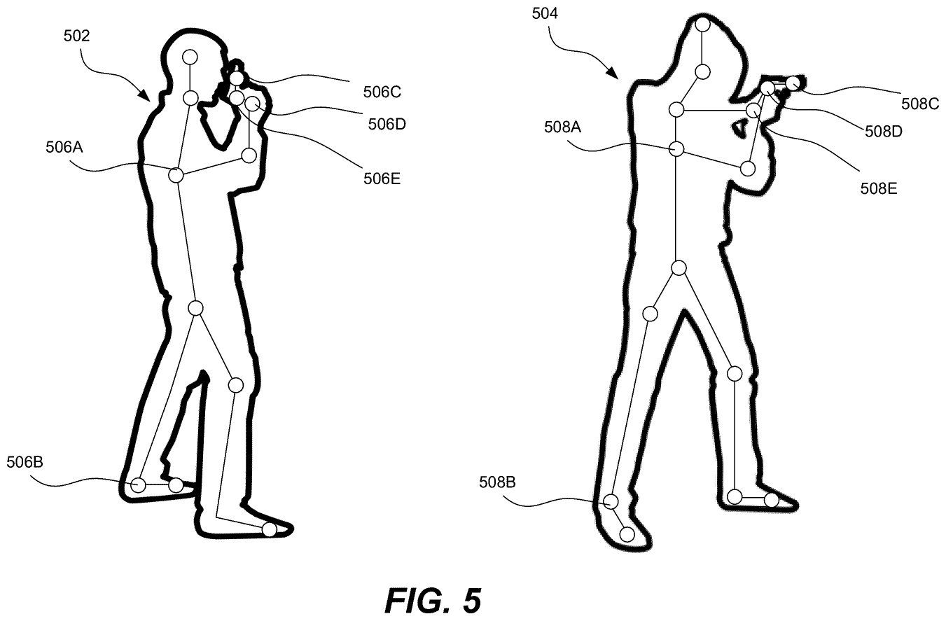

Returning to FIG. 1, along with the first layer of discrimination (or verification), e.g., the analysis of sounds by the sound analyzer 112, the shot timer 102 performs a second layer of verification. In some examples, the shot timer 102 uses pre-discharge visual processing technologies to discriminate between individuals having body movements/positions indicative of a person ready to or currently discharging their firearm and other individuals either at rest or not discharging their firearms. In some examples, a camera of the hybrid shot timer uses skeletal tracking to identify and track those body movements as well as movements of the firearm, explained by way of example in FIG. 5.

FIG. 5 illustrates the use of skeleton tracking to determine which, if any, individual discharged a firearm, in accordance with one or more examples of the presently disclosed subject matter. In some examples, skeleton tracking uses sensors, such as a camera 120 illustrated in FIG. 1. In some examples, the camera 120 may be one or more cameras capable of tracking the motion of a human being. The camera 120 differentiates a human from the background and then identifies features of the human such as joints, shoulders, knees, elbows and hands. Once those joints are identified, in some examples, a posture analyzer 122 uses the features and connects them to form a humanoid skeleton capable of being tracked. It should be noted that other technologies may be used by the shot timer 102 to determine and track the movement of one or more human bodies and are considered to be within the scope of the present disclosure. For example, skeletal tracking software using a machine learning approach can be used. Images or depth images can be labelled to create training data sets where the position of the joints and skeleton has been marked manually, and then from there, that data is used to train the software so that it can recognize joint positions or multiple people in real time.

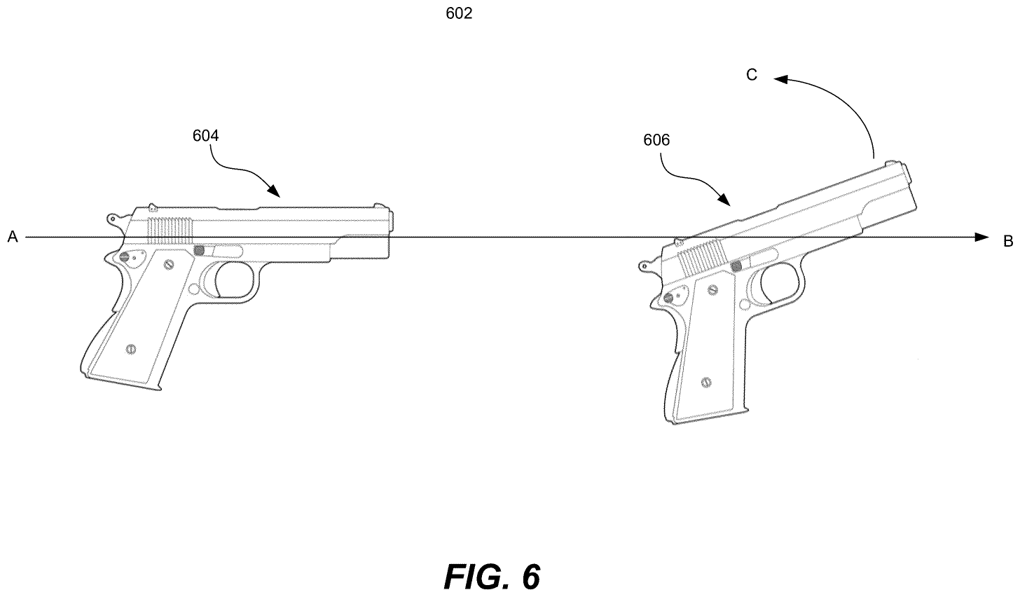

FIG. 5 includes a skeleton FIG. 502 and a skeleton FIG. 504. The skeleton FIG. 502 is formed from features, such as features 506A, 506B, 506C,506D, and 506E, identified for a first user. The skeleton FIG. 504 is formed from features, such as features 508A, 508B, 508C, 508D, and 508E, identified for a second user. A posture analyzer 122 illustrated in FIG. 1 is configured to analyze the features and determine if the user is in a standby or non-firing position, or if the user is in a ready or firing position. Users determined to be in a standby or non-firing position can be eliminated as potential users that discharged a firearm. In FIG. 5, the first user is determined by the posture analyzer 122 as being in a standby or non-firing position, indicated by a firearm being directed towards the sky or upward, shown by the features 506C, 506D, and 506E. By way of contrast, the second user is determined by the posture analyzer 122 as being in ready or firing position, indicated by a firearm being directed towards a target, shown by the features 508C, 508D, and 508E. In this example, upon receiving a sound signal indicating the discharge of a firearm, the shot timer 102 may eliminate the first user as being the user that discharged the firearm. Because the second user in a ready or firing position, upon receiving the sound signal indicating the discharge of a firearm, the shot timer 102 may indicate that the second user may have discharged their firearm. Thus, in the second level, the first user is eliminated as a potential source of the sound signal. However, in some examples, a user being in a ready or firing position may not be dispositive as being the user that discharged a firearm, as the user may simply be in the position without discharging the firearm resulting in the sound signal received by the shot timer 102. Thus, in some examples, a third level using post-discharge firearm or posture behavior may be used, described in FIG. 6.

FIG. 6 illustrates a firearm 602 in a pre-discharge position 604 and a post-discharge position 606, in accordance with one or more examples of the presently disclosed subject matter. The firearm 602 position is illustrated in reference to axis AB, which may be a direction generally from a user (position A) towards a target (position B). A weapon position analyzer 124 illustrated in FIG. 1 may be configured to detect the position of the firearm 602 using the camera 120. In FIG. 6, the pre-discharge position 604 indicates that the firearm 602 is in a ready to fire position, whereby the firearm 602 is pointed at the target. Further, in FIG. 6, the post-discharge position 606 indicates that the firearm 602 has rotated along curve C due to the recoil caused by the discharging of the firearm 602. Thus, if the shot timer 102 received an audio signal, the shot timer 102 can eliminate firearms that, during the time of the generation of the audio signal, have not moved from the pre-discharge position 604, indicating that the firearm has not been discharged and therefore, could not be the source of the audio signal. In a similar manner, if the shot timer 102 received an audio signal, the shot timer 102 can include firearms that, during the time of the generation of the audio signal, have moved from the pre-discharge position 604 to the post-discharge position 606. Other visual cues may be used to determine if the firearm 602 has been discharged, such as, but not limited to, a detection of a slide of the firearm 602 moving, detecting a shell casing being ejected from the firearm 602, and the like. Another visual cue to determine if the firearm 602 has been discharged may be the detection of a muzzle flash, described further in FIG. 1.

Returning to FIG. 1, the shot timer 102 may further include a flash detector 126. When some firearms discharge, the firearms can suddenly release high-temperature, high-pressure gases from the muzzle of the firearm. These gases, along with the burning of any remaining gunpower, can sometimes be seen as intense sources of light, i.e., a muzzle flash. In a manner similar to the movement of the firearm 602 in FIG. 6 moving from the pre-discharge position 604 to the post-discharge position 606, if available, the flash detector 126 can be used to detect which firearm has been discharged during the period in which an audio signal was generated.

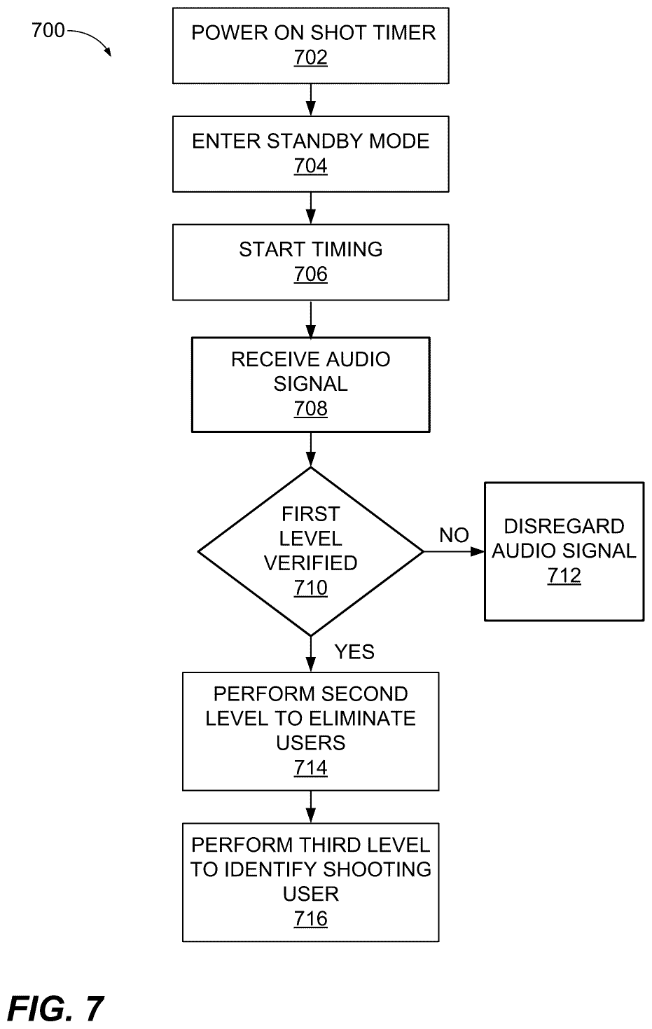

FIG. 7 illustrates a method 700 for timing discharges of one or more firearms, in accordance with various examples of the presently disclosed subject matter. The method 700 and other processes described herein are illustrated as example flow graphs, each operation of which may represent a sequence of operations that can be implemented in hardware, software, or a combination thereof. In the context of software, the operations represent computer-executable instructions stored on one or more tangible computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

The method 700 commences at step 702, wherein the shot timer 102 is powered on. In some examples, the shot timer 102 may be a stand-alone device having its own power supply. In other examples, the shot timer 102 may be an application executed on a user device, such as a cell phone, and thus is powered on when the application is executed on the user device. In still further examples, the shot timer 102 may be one or more applications running on one or more user devices and in communication with a central service.

At step 704, the shot timer 102 is in a standby mode. As used herein, a “standby mode” is a operational condition of the shot timer 102 in which the shot timer 102 is powered on and ready to accept an input.

At step 706, the shot timer 102 timing is commenced. The timing may be commenced using various methods. For example, a user may provide an input to cause the shot timer 102 to produce an audible signal notifying users of the initiation of the shot timer 102. In other examples, the shot timer 102 may receive an audible input, such as verbal command or sound that indicates an intent to start the internal timer of the shot timer 102. The present disclosure is not limited to any particular method of commencing the timer of the shot timer 102.

At step 708, an audio signal is received by the shot timer 102. The audio signal may be sound detected by the microphone 114 of the shot timer 102. In other examples, the audio signal may be a sound file or data provided to the shot timer 102. In this example, the audio signal may be data received by the shot timer 102 in which the shot timer 102 calculates the time to discharge a weapon using only the audio signal.

At step 710, the shot timer 102 performs the first level verification process. As described above, the first level verification process involves analyzing audio signals received by the shot timer 102 and disregarding audio signals that are not associated with the discharge of a firearm. The present disclosure can use various technologies to perform the first level verification process. An example was described in FIG. 2, whereby the shot timer 102 analyzed the waveform of the audio signal to determine if the waveform had characteristics indicative of the discharge of a firearm. Another example was described in FIG. 3, whereby the shot timer 102 matched the audio signal to knew audio signals to determine if the received audio signal has a waveform similar to known audio signals. If the first level verification process at step 710 indicates that the received audio signal is not associated with the discharge of a firearm, the method proceeds to step 712, where the audio signal is disregarded for the purposes of timing a discharge of a firearm.

If at step 710, the shot timer 102 determines that the audio signal is associated with the discharge of a firearm, the method 700 continues to step 714, where a second level verification process is performed. In some examples, the purpose of the second level verification is to identify individuals that could be associated with the discharge of the firearm that produced the audio signal. An example of the second level verification process is described by way of example in FIG. 5. As described by way of example in FIG. 5, the shot timer 102 uses a camera or other technology to recognize a posture of one or more individuals that may have discharged the firearm that produced the audio signal. The shot timer 102 creates a skeletal figure of the users. The skeletal figure is analyzed to determine if the individual has a posture that indicates the individual could have discharged the firearm. If the skeletal figure indicates that the individual is in a standby or nonfiring position, the individual is eliminated from consideration as being an individual that discharged the firearm, producing the audio signal.

At step 716, the shot timer 102 analyzes the various aspects of the individuals not eliminated from consideration in step 714. An example is provided in FIG. 6, whereby the shot timer 102 detects the movement of a firearm from a pre-discharge position to a post-discharge position. In another example, the shot timer 102 may detect a muzzle flash or other movement of a component of the firearm indicating that the firearm has been discharged. The method 700 thereafter ends after the individual that discharged the firearm producing the audio signal is identified. It should be noted that present disclosure does not require the performance of the three levels of verification. For example, in some uses, the different levels of verification may be used alone or in various combinations with other levels of verification.

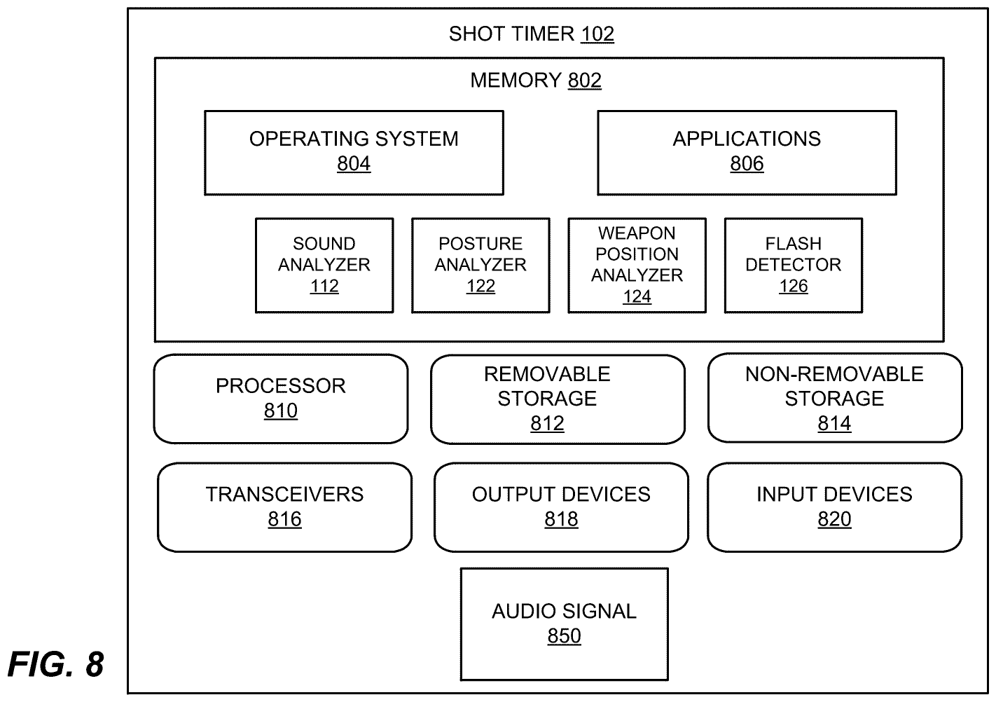

FIG. 8 depicts a component level view of the shot timer 102 for use with the systems and methods described herein, in accordance with various examples of the presently disclosed subject matter. The shot timer 102 could be any device capable of providing the functionality associated with the systems and methods described herein. The shot timer 102 can comprise several components to execute the above-mentioned functions. The shot timer 102 may be comprised of hardware, software, or various combinations thereof. The shot timer 102 can be an application operating on a user device, a device configured to perform the functions described herein, a system or network configured to perform the functions described herein, or combinations thereof. As discussed below, the shot timer 102 can comprise memory 802 including an operating system (OS) 804 and one or more standard applications 806. The standard applications 806 may include applications such as, but not limited to, the sound analyzer 112, the posture analyzer 122, the weapon position analyzer 124, and the flash detector 126.

The shot timer 102 can also comprise one or more processors 810 and one or more of removable storage 812, non-removable storage 814, transceiver(s) 816, output device(s) 818, and input device(s) 820. In various implementations, the memory 802 can be volatile (such as random access memory (RAM)), non-volatile (such as read only memory (ROM), flash memory, etc.), or some combination of the two. The memory 802 can include data pertaining to an audio signal 850 received by the microphone 114.

The memory 802 can also include the OS 804. The OS 804 varies depending on the manufacturer of the shot timer 102. The OS 804 contains the modules and software that support basic functions of the shot timer 102, such as scheduling tasks, executing applications, and controlling peripherals. The OS 804 can also enable the shot timer 102 to send and retrieve other data and perform other functions.

The shot timer 102 can also comprise one or more processors 810. In some implementations, the processor(s) 810 can be one or more central processing units (CPUs), graphics processing units (GPUs), both CPU and GPU, or any other combinations and numbers of processing units. The shot timer 102 may also include additional data storage devices (removable and/or non-removable) such as, for example, magnetic disks, optical disks, or tape. Such additional storage is illustrated in FIG. 8 by removable storage 812 and non-removable storage 814.

Non-transitory computer-readable media may include volatile and nonvolatile, removable and non-removable tangible, physical media implemented in technology for storage of information, such as computer readable instructions, data structures, program modules, or other data. The memory 802, removable storage 812, and non-removable storage 814 are all examples of non-transitory computer-readable media. Non-transitory computer-readable media include, but are not limited to, RAM, ROM, electronically erasable programmable ROM (EEPROM), flash memory or other memory technology, compact disc ROM (CD-ROM), digital versatile discs (DVD) or other optical storage, magnetic cassettes, magnetic tape, magnetic disk storage or other magnetic storage devices, or any other tangible, physical medium which can be used to store the desired information, which can be accessed by the shot timer 102. Any such non-transitory computer-readable media may be part of the shot timer 102 or may be a separate database, databank, remote server, or cloud-based server.

In some implementations, the transceiver(s) 816 include any transceivers known in the art. In some examples, the transceiver(s) 816 can include wireless modem(s) to facilitate wireless connectivity with other components, the Internet, and/or an intranet. Thus, the transceiver(s) 816 can include multiple single-channel transceivers or a multi-frequency, multi-channel transceiver to enable the shot timer 102 to send and receive video calls, audio calls, messaging, etc. The transceiver(s) 816 can enable the shot timer 102 to connect to multiple networks including, but not limited to 2G, 3G, 4G, 5G, and Wi-Fi networks. The transceiver(s) 816 can also include one or more transceivers to enable the shot timer 102 to connect to future (e.g., 6G) networks, Internet-of-Things (IoT), machine-to machine (M2M), and other current and future networks.

The transceiver(s) 816 may also include one or more radio transceivers that perform the function of transmitting and receiving radio frequency communications via an antenna (e.g., Wi-Fi or Bluetooth®). In other examples, the transceiver(s) 816 may include wired communication components, such as a wired modem or Ethernet port, for communicating via one or more wired networks. The transceiver(s) 816 can enable the shot timer 102 to facilitate audio and video calls, download files, access web applications, and provide other communications associated with the systems and methods, described above.

In some implementations, the output device(s) 818 include any output devices known in the art, such as a display (e.g., a liquid crystal or thin-film transistor (TFT) display), a touchscreen, speakers, a vibrating mechanism, or a tactile feedback mechanism. Thus, the output device(s) can include a screen or display. The output device(s) 818 can also include speakers, or similar devices, to play sounds or ringtones when an audio call or video call is received. Output device(s) 818 can also include ports for one or more peripheral devices, such as headphones, peripheral speakers, or a peripheral display.

In various implementations, input device(s) 820 include any input devices known in the art. For example, the input device(s) 820 may include a camera, a microphone, or a keyboard/keypad. The input device(s) 820 can include a touch-sensitive display or a keyboard to enable users to enter data and make requests and receive responses via web applications (e.g., in a web browser), make audio and video calls, and use the standard applications 806, among other things. A touch-sensitive display or keyboard/keypad may be a standard push button alphanumeric multi-key keyboard (such as a conventional QWERTY keyboard), virtual controls on a touchscreen, or one or more other types of keys or buttons, and may also include a joystick, wheel, and/or designated navigation buttons, or the like. A touch sensitive display can act as both an input device 820 and an output device 818.

Some aspects of the present disclosure may be described in one or more of the following clauses and in various combinations of the following clauses:

Clause 1. A method of timing a discharge of a firearm, comprising: initiating a timer of a shot timer; receiving an audio signal; performing a first level of analysis by analyzing the audio signal; performing a second level of analysis by analyzing a posture change of an individual; performing a third level of analysis by analyzing a movement of the firearm; and outputting a time based on the first level, the second level, and the third level of analysis.

Clause 2. The method of clause 1, wherein initiating the timer comprises sounding a signal to indicate to one or more individuals to commence discharging a firearm.

Clause 3. The method of clause 1, wherein initiating the timer comprises receiving an input that a training session has commenced.

Clause 4. The method of clause 1, wherein the audio signal is received at a microphone of the shot timer.

Clause 5. The method of clause 1, wherein performing the first level of analysis by analyzing the audio signal comprises: identifying a starting time of a sound comprising the audio signal; identifying a first time for the sound to reach a maximum amplitude; and analyzing the starting time and the first time to determine that the sound was generated by a firearm.

Clause 6. The method of clause 1, wherein performing the first level of analysis by analyzing the audio signal comprises matching a sound comprising the audio signal to a sound stored in a sound data store.

Clause 7. The method of clause 1, wherein performing the second level of analysis by analyzing the posture change of the individual comprises: generating a skeleton figure of the individual; determining, using the skeleton figure, if the individual is in a standby position or a ready position; eliminating the individual as a potential source of the audio signal if the individual is in a standby position.

Clause 8. The method of clause 1, wherein performing the third level of analysis by analyzing the movement of the firearm comprises determining that the firearm has moved to indicate a recoil of the firearm.

Clause 9. The method of clause 1, wherein performing the third level of analysis by analyzing the movement of the firearm comprises detecting a muzzle flash of the firearm.

Clause 10. The method of clause 1, further comprising receiving an input that the audio signal was generated by a type of firearm.

Clause 11. The method of clause 1, further comprising receiving an input that the audio signal was generated by a type of ammunition.

Clause 12. The method of clause 1, further comprising receiving an input that the audio signal was generated by a specific individual.

Clause 13. A shot timer comprising: a memory storing computer-executable instructions; and a processor in communication with the memory, the computer-executable instructions causing the processor to perform acts comprising: initiating a timer of a shot timer; receiving an audio signal; performing a first level of analysis by analyzing the audio signal; performing a second level of analysis by analyzing a posture change of an individual; performing a third level of analysis by analyzing a movement of a firearm; and outputting a time based on the first level, the second level, and the third level of analysis.

Clause 14. The shot timer of clause 13, wherein the computer-executable instructions causing the processor to perform acts comprising initiating the timer comprises sounding a signal to indicate to one or more individuals to commence discharging a firearm.

Clause 15. The shot timer of clause 13, wherein the computer-executable instructions causing the processor to perform acts comprising initiating the timer comprises receiving an input that a training session has commenced.

Clause 16. The shot timer of clause 13, wherein the computer-executable instructions causing the processor to perform acts comprising performing the first level of analysis by analyzing the audio signal comprises: identifying a starting time of a sound comprising the audio signal; identifying a first time for the sound to reach a maximum amplitude; and analyzing the starting time and the first time to determine that the sound was generated by a firearm.

Clause 17. The shot timer of clause 13, wherein the computer-executable instructions causing the processor to perform acts comprising performing the first level of analysis by analyzing the audio signal comprises matching a sound comprising the audio signal to a sound stored in a sound data store.

Clause 18. The shot timer of clause 13, wherein the computer-executable instructions causing the processor to perform acts comprising performing the second level of analysis by analyzing the posture change of the individual comprises: generating a skeleton figure of the individual; determining, using the skeleton figure, if the individual is in a standby position or a ready position; and eliminating the individual as a potential source of the audio signal if the individual is in a standby position.

Clause 19. A non-transitory computer-readable media storing computer-executable instructions that, when executed by one or more processors, cause the one or more processors to perform operations comprising: receiving an audio signal; performing a first level of analysis by analyzing the audio signal; performing a second level of analysis by analyzing a posture change of an individual; performing a third level of analysis by analyzing a movement of a firearm; and outputting a time based on the first level, the second level, and the third level of analysis.

Clause 20. The non-transitory computer-readable media of clause 19, further comprising computer-executable instructions that, when executed by one or more processors, cause the one or more processors to perform operations comprising: receiving an input that the audio signal was generated by a type of firearm; receiving an input that the audio signal was generated by a type of ammunition; or receiving an input that the audio signal was generated by a specific individual.

Unless explicitly excluded, the use of the singular to describe a component, structure, or operation does not exclude the use of plural such components, structures, or operations or their equivalents. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

While aspects of the present disclosure have been particularly shown and described with reference to the embodiments above, it will be understood by those skilled in the art that various additional embodiments may be contemplated by the modification of the disclosed systems and methods without departing from the spirit and scope of what is disclosed. Such embodiments should be understood to fall within the scope of the present disclosure as determined based upon the claims and any equivalents thereof.

What is claimed is:

1. A method of timing a discharge of a firearm, comprising:
initiating a timer of a shot timer;
receiving an audio signal;
performing a first level of analysis by analyzing the audio signal;
performing a second level of analysis by analyzing a posture change of an individual;
performing a third level of analysis by analyzing a movement of the firearm; and
outputting a time based on the first level, the second level, and the third level of analysis.

2. The method of claim 1, wherein initiating the timer comprises sounding a signal to indicate to one or more individuals to commence discharging a firearm.

3. The method of claim 1, wherein initiating the timer comprises receiving an input that a training session has commenced.

4. The method of claim 1, wherein the audio signal is received at a microphone of the shot timer.

5. The method of claim 1, wherein performing the first level of analysis by analyzing the audio signal comprises:
identifying a starting time of a sound comprising the audio signal;
identifying a first time for the sound to reach a maximum amplitude; and
analyzing the starting time and the first time to determine that the sound was generated by a firearm.

6. The method of claim 1, wherein performing the first level of analysis by analyzing the audio signal comprises matching a sound comprising the audio signal to a sound stored in a sound data store.

7. The method of claim 1, wherein performing the second level of analysis by analyzing the posture change of the individual comprises:
generating a skeleton figure of the individual;
determining, using the skeleton figure, if the individual is in a standby position or a ready position;
eliminating the individual as a potential source of the audio signal if the individual is in a standby position.

8. The method of claim 1, wherein performing the third level of analysis by analyzing the movement of the firearm comprises determining that the firearm has moved to indicate a recoil of the firearm.

9. The method of claim 1, wherein performing the third level of analysis by analyzing the movement of the firearm comprises detecting a muzzle flash of the firearm.

10. The method of claim 1, further comprising receiving an input that the audio signal was generated by a type of firearm.

11. The method of claim 1, further comprising receiving an input that the audio signal was generated by a type of ammunition.

12. The method of claim 1, further comprising receiving an input that the audio signal was generated by a specific individual.

13. A shot timer comprising:
a memory storing computer-executable instructions; and
a processor in communication with the memory, the computer-executable instructions causing the processor to perform acts comprising:
initiating a timer of a shot timer;
receiving an audio signal;
performing a first level of analysis by analyzing the audio signal;
performing a second level of analysis by analyzing a posture change of an individual;
performing a third level of analysis by analyzing a movement of a firearm; and
outputting a time based on the first level, the second level, and the third level of analysis.

14. The shot timer of claim 13, wherein the computer-executable instructions causing the processor to perform acts comprising initiating the timer comprises sounding a signal to indicate to one or more individuals to commence discharging a firearm.

15. The shot timer of claim 13, wherein the computer-executable instructions causing the processor to perform acts comprising initiating the timer comprises receiving an input that a training session has commenced.

16. The shot timer of claim 13, wherein the computer-executable instructions causing the processor to perform acts comprising performing the first level of analysis by analyzing the audio signal comprises:
identifying a starting time of a sound comprising the audio signal;
identifying a first time for the sound to reach a maximum amplitude; and
analyzing the starting time and the first time to determine that the sound was generated by a firearm.

17. The shot timer of claim 13, wherein the computer-executable instructions causing the processor to perform acts comprising performing the first level of analysis by analyzing the audio signal comprises matching a sound comprising the audio signal to a sound stored in a sound data store.

18. The shot timer of claim 13, wherein the computer-executable instructions causing the processor to perform acts comprising performing the second level of analysis by analyzing the posture change of the individual comprises:
generating a skeleton figure of the individual;
determining, using the skeleton figure, if the individual is in a standby position or a ready position; and
eliminating the individual as a potential source of the audio signal if the individual is in a standby position.

19. A non-transitory computer-readable media storing computer-executable instructions that, when executed by one or more processors, cause the one or more processors to perform operations comprising:
receiving an audio signal;
performing a first level of analysis by analyzing the audio signal;
performing a second level of analysis by analyzing a posture change of an individual;
performing a third level of analysis by analyzing a movement of a firearm; and
outputting a time based on the first level, the second level, and the third level of analysis.

20. The non-transitory computer-readable media of claim 19, further comprising computer-executable instructions that, when executed by one or more processors, cause the one or more processors to perform operations comprising:
receiving an input that the audio signal was generated by a type of firearm;
receiving an input that the audio signal was generated by a type of ammunition; or
receiving an input that the audio signal was generated by a specific individual.
